(19) United States
(12) Patent Application Publication
(10) Pub. No.: US 2019/0251836 A1
(43) Pub. Date: Aug. 15, 2019

(54) CONCEPT FOR DETECTING THE SURROUNDINGS OF A MOTOR VEHICLE

(71) Applicant: Robert Bosch GmbH, Stuttgart (DE)

(72) Inventors: Albrecht Irion, Stuttgart (DE); Philipp Mayer, Ho Chi Minh City (VN); Rolf Nicodemus, Bietigheim-Bissingen (DE); Stefan Nordbruch, Kornwestheim (DE)

(73) Assignee: Robert Bosch GmbH, Stuttgart (DE)

(21) Appl. No.: 16/331,748

(22) PCT Filed: Aug. 14, 2017
(86) PCT No.: PCT/EP2017/070610

§ 371 Date: Mar. 8, 2019

(30) Foreign Application Priority Data
Sep. 9, 2016 (DE) 102016217246.8

(51) Int. Cl. G08G 1/01; H04W 4/44; G07C 5/00

(52) U.S. Cl. CPC G08G 1/0112; G07C 5/008; H04W 4/44; G08G 1/0141

(57) ABSTRACT

A device is described for detecting the surroundings of a motor vehicle, including: one or multiple sensor units, each including one or multiple surroundings sensors for detecting the surroundings of a motor vehicle, and a communication interface for wirelessly transmitting surroundings sensor data, corresponding to the particular detection, to a data processing device via a wireless communications network, so that the data processing device may transmit the surroundings sensor data and/or surroundings data based on the surroundings sensor data to a cloud server via a further wireless communications network. Moreover, a motor vehicle, a method for detecting the surroundings of a motor vehicle, a method for processing a motor vehicle, a system for detecting the surroundings of a motor vehicle, and a computer program are described.

### FIELD OF THE INVENTION

The present invention relates to a device and a method for detecting the surroundings of a motor vehicle. Moreover, the present invention relates to a motor vehicle. Furthermore, the present invention relates to a system for detecting the surroundings of a motor vehicle. Moreover, the present invention relates to a method for processing a motor vehicle, and a computer program.

### BACKGROUND INFORMATION

Systems for ascertaining parking spaces on a roadside are known per se. They generally include two subsystems: a first subsystem is situated in the motor vehicle and a second subsystem is situated in a cloud infrastructure.

The subsystem that is situated in the motor vehicle includes surroundings sensors that scan a roadside when the motor vehicle is traveling along the roadside. The raw sensor data are subsequently further processed in a parking control unit of the motor vehicle. This means, for example, that occupied or vacant spaces as well as their dimensions or distances from one another are ascertained in the parking control unit.

In a so-called “head unit”, the main control unit of the motor vehicle, or optionally in another computer, a position of the occupied or vacant spaces is additionally ascertained with the aid of a GPS sensor, for example.

These data (position of the ascertained space and its occupancy state, i.e., vacant or occupied) are sent via a communication unit of the motor vehicle to the subsystem situated in the cloud infrastructure.

The subsystem situated in the cloud infrastructure processes these data and determines, for example, whether or not a vacant space is an entry point. These further processed data are then, for example, transmitted back to the motor vehicle or to other motor vehicles, so that the information contained in these further processed data may be displayed in the particular motor vehicle and/or provided via the Internet.

Thus, an appropriately designed parking control unit must be situated in the motor vehicle. In particular, a position ascertainment component such as a GPS sensor must be situated within the motor vehicle. In particular, a communication component for communicating with the subsystem that is situated within the cloud infrastructure must be situated within the motor vehicle.

In addition, modifications to a vehicle-internal communication, for example to a bus system of the motor vehicle, are generally necessary.

For these reasons, subsequently installing the first subsystem, situated in the motor vehicle, in a completed motor vehicle, i.e., after its manufacture, is possible, if at all, only with significant modifications.

### SUMMARY

An object underlying the present invention is to be seen as providing an efficient concept for efficiently detecting the surroundings of a motor vehicle, which overcomes the above-described disadvantages and efficiently allows a motor vehicle to become part of a system for ascertaining parking spaces also subsequently, i.e., after its manufacture.

This object is achieved by the respective subject matter of the independent claims. Advantageous embodiments of the present invention are the subject matter of the respective dependent subclaims.

According to one aspect, a device for detecting the surroundings of a motor vehicle is provided, including:
one or multiple sensor units, each including one or multiple surroundings sensors for detecting the surroundings of a motor vehicle, and a communication interface for wirelessly transmitting surroundings sensor data, corresponding to the particular detection, to a data processing device via a wireless communications network, so that the data processing device may transmit the surroundings sensor data and/or the surroundings data to a cloud server via a further wireless communications network.

According to another aspect, a motor vehicle is provided that includes the device for detecting the surroundings of a motor vehicle.

According to another aspect, a method for detecting the surroundings of a motor vehicle, using the device for detecting the surroundings of a motor vehicle, is provided, including the following steps:
detecting the surroundings of a motor vehicle with the aid of the surroundings sensor(s),
wirelessly transmitting surroundings sensor data, corresponding to the detection, with the aid of the particular communication interface to a data processing device of the motor vehicle via a wireless communications network, so that the surroundings sensor data may be received with the aid of the data processing device, so that the surroundings sensor data and/or surroundings data based on the surroundings sensor data may be transmitted to a cloud server via a further wireless communications network, with the aid of the data processing device.

According to yet another aspect, a method for processing a motor vehicle is provided, the motor vehicle including one or multiple sensor units, each including one or multiple surroundings sensors for detecting the surroundings of a motor vehicle, and a communication interface for the wired transmission of surroundings sensor data corresponding to the particular detection via a bus, in particular a CAN bus, of the motor vehicle, one or multiple or all of the sensor units in each case being exchanged with another sensor unit that in each case includes one or multiple surroundings sensors for detecting the surroundings of a motor vehicle and a communication interface for wirelessly transmitting surroundings sensor data corresponding to the particular detection to a data processing device.

According to another aspect, a system for detecting the surroundings of a motor vehicle is provided, including
the device for detecting the surroundings of a motor vehicle,
a cloud server that includes a communication interface that is designed for receiving the surroundings sensor data and/or the surroundings data via the further wireless communications network.

According to another aspect, a computer program is provided that includes program code for carrying out the method for detecting the surroundings of a motor vehicle when the computer program is executed on a computer.

The present invention is based on the finding that the above-mentioned object may be achieved in that the sensor units of the motor vehicle, which with their surroundings sensors detect the surroundings of the motor vehicle, wirelessly communicate with the data processing device in order to wirelessly transmit the surroundings sensor data to the data processing device via a wireless communications network. This means that the surroundings sensor data are transmitted wirelessly, not via a bus, to the data processing device. As a result, it is thus advantageously not necessary to make modifications to a motor vehicle bus.

In particular, a parking control unit of the motor vehicle that may already be present does not have to be modified.

As a result, a motor vehicle after manufacture may participate as a part of a system for ascertaining parking spaces. For this purpose, the motor vehicle only has to be provided with one or multiple sensor units, each of which includes one or multiple surroundings sensors for detecting the surroundings of a motor vehicle, and a communication interface for wirelessly transmitting surroundings sensor data, corresponding to the particular detection, to a data processing device.

This means that advantageously only sensor units that are already present have to be exchanged in order for the motor vehicle to be part of a system for ascertaining parking spaces.

In one specific embodiment, the device for detecting the surroundings of a motor vehicle includes the data processing device, the data processing device including a communication module, the communication module being designed for wirelessly receiving the surroundings sensor data, the communication module being designed for transmitting the surroundings sensor data and/or the surroundings data to the cloud server via the further wireless communications network.

According to one specific embodiment, it is provided that the data processing device is a mobile terminal, in particular a mobile telephone.

This yields, for example, the technical advantage that, for example, a mobile terminal, in particular a mobile telephone, of a driver of the motor vehicle may be efficiently utilized.

According to another specific embodiment, it is provided that the data processing device is a main control unit for a motor vehicle.

This yields, for example, the technical advantage that the main control unit may be efficiently utilized.

Within the meaning of the description, a main control unit may be referred to as a head unit, for example.

According to one specific embodiment, it is provided that the communication module includes a first communication interface, in particular a WLAN or a Bluetooth communication interface, for receiving the surroundings sensor data, and a second communication interface, in particular a mobile radio communication interface, for transmitting the surroundings sensor data and/or the surroundings data to the cloud server.

This yields, for example, the technical advantage that the surroundings sensor data or the surroundings data may each be efficiently transmitted to the cloud server.

According to one specific embodiment, it is provided that the data processing device is designed to ascertain, based on the surroundings sensor data, dimensions of a vacant space in the surroundings and/or dimensions of a space in the surroundings that is occupied by a motor vehicle, and to ascertain surroundings data corresponding to the ascertainment of the particular dimensions.

This yields in particular the technical advantage that the data processing device may be efficiently utilized. This yields in particular the technical advantage that the cloud server may be relieved of this task.

According to one specific embodiment, it is provided that a position sensor for detecting a position of the motor vehicle is provided, the data processing device being designed for transmitting position data corresponding to the detection of the position to the cloud server via the further wireless communications network.

This yields in particular the technical advantage that the position of the detected surroundings may be efficiently ascertained, and may be efficiently provided to the cloud server remote from the motor vehicle.

According to one specific embodiment, it is provided that the position sensor is integrated into the data processing device.

According to one specific embodiment, it is provided that the sensor unit(s) is/are designed for encrypting the surroundings sensor data, the particular communication interface of the sensor unit(s) being designed for wirelessly transmitting the encrypted surroundings sensor data to the data processing device.

This yields in particular the technical advantage that the surroundings sensor data may be protected from unauthorized readout.

According to one specific embodiment, it is provided that the communication module is designed for wirelessly receiving the encrypted surroundings sensor data.

According to one specific embodiment, it is provided that the data processing device is designed for decrypting the encrypted surroundings sensor data.

According to one specific embodiment, it is provided that the data processing device is designed for encrypting unencrypted surroundings sensor data and/or unencrypted surroundings data.

According to one specific embodiment, it is provided that the communication module is designed for transmitting the encrypted surroundings sensor data and/or the encrypted surroundings data to the cloud server via the further wireless communications network.

According to one specific embodiment, the sensor unit(s) include(s) a processor that is designed for encrypting the surroundings sensor data.

According to one specific embodiment, the surroundings sensor data are raw surroundings sensor data or include raw surroundings sensor data.

Within the meaning of the description, a surroundings sensor is, for example, one of the following surroundings sensors: a radar sensor, a LIDAR sensor, a video sensor, in particular a video sensor of a video camera, a laser sensor, an ultrasonic sensor, a magnetic sensor, or an infrared sensor.

For multiple surroundings sensors, these have identical or different designs, for example.

According to one specific embodiment, it is provided that the device for detecting the surroundings of a motor vehicle is designed or configured for executing or carrying out the method for detecting the surroundings of a motor vehicle.

According to one specific embodiment, it is provided that the method for detecting the surroundings of a motor vehicle is executed or carried out with the aid of the device for detecting the surroundings of a motor vehicle.

Technical functionalities of the device for detecting the surroundings of a motor vehicle analogously result from corresponding technical functionalities of the method for detecting the surroundings of a motor vehicle, and vice versa.

According to one specific embodiment, it is provided that the motor vehicle is designed or configured for executing or carrying out the method for detecting the surroundings of a motor vehicle.

According to one specific embodiment, the further wireless communications network includes a mobile radio communications network.

According to one specific embodiment, it is provided that the surroundings sensor data are wirelessly transmitted from the particular sensor unit to the data processing device via a wireless communications network.

In one specific embodiment, the wireless communications network includes a WLAN communications network and/or a Bluetooth communications network.

According to one specific embodiment, the other sensor unit, which in the method for processing a motor vehicle is used for the exchange, is the sensor unit of the device for detecting the surroundings of a motor vehicle.

According to one specific embodiment of the method for processing a motor vehicle, it is provided that a data processing device is installed in the motor vehicle. The data processing device is, for example, a mobile terminal, in particular a mobile telephone, or a main control unit.

Technical functionalities of the method for processing a motor vehicle analogously result from corresponding technical functionalities of the device for detecting the surroundings of a motor vehicle, and vice versa.

In one specific embodiment of the method for detecting the surroundings of a motor vehicle, the method includes the following steps:
wirelessly receiving the surroundings sensor data with the aid of the data processing device,
transmitting the surroundings sensor data and/or the surroundings data to the cloud server via the further wireless communications network, with the aid of the data processing device.

In one specific embodiment, a parking control unit is provided which is designed for at least semiautonomously, in particular fully autonomously, parking and/or unparking a motor vehicle. The parking control unit is in particular designed for controlling transverse and/or longitudinal guiding of a motor vehicle.

In one specific embodiment, the motor vehicle includes the parking control unit.

In one specific embodiment, the device for detecting the surroundings of a motor vehicle includes the parking control unit.

In one specific embodiment, it is provided that the sensor unit(s) include(s) a bus communication interface that is designed for wired transmission of the surroundings sensor data to the parking control unit via a bus. This means in particular that, in addition to the wireless transmission to the data processing device, it may be provided to transmit the surroundings sensor data to the parking control unit. The parking control unit is designed for parking and/or unparking the motor vehicle based on the surroundings sensor data.

Within the meaning of the description, a bus includes a CAN bus and/or a FlexRay bus, for example.

In one specific embodiment, the motor vehicle includes a bus.

In one specific embodiment, it is provided that the sensor unit(s) is/are connected to the parking control unit by cables. This means, for example, that the sensor unit(s) transmit(s) its/their surroundings data to the parking control unit by cable or wire, for example via a bus, for example a CAN bus and/or a FlexRay bus.

This means that in one specific embodiment, two communication paths or communication options are provided: cabled communication, preferably via a bus, from the sensor unit(s) to the parking control unit, and cable-free or wireless communication to the data processing device via a wireless communications network.

The parking control unit may then, for example, further process the surroundings sensor data as described in the introduction to the description. This means, for example, that occupied or vacant spaces as well as their dimensions or distances from one another are ascertained in the parking control unit. These pieces of information are then transmitted, for example, to the main control unit via the bus. The main control unit then transmits, for example, the received pieces of information to the cloud server via the further wireless communications network.

Surroundings sensor data refer to data which originate directly from the surroundings sensors and which may include raw surroundings sensor data, for example.

Surroundings data refer to data that are computed or ascertained based on the surroundings data. Surroundings data include, for example, dimensions of an occupied or unoccupied space and/or an occupancy state of a space.

In one specific embodiment, it is provided that the cloud server is designed to ascertain, based on the surroundings sensor data and/or on the surroundings data, dimensions of a vacant space in the surroundings and/or dimensions of a space in the surroundings that is occupied by a motor vehicle, and to ascertain surroundings data corresponding to the ascertainment of the particular dimensions.

The phrase “respective” encompasses in particular the phrase “and/or”.

### BRIEF DESCRIPTION OF THE DRAWINGS

FIG. 1 shows a device for detecting the surroundings of a motor vehicle.

FIG. 2 shows a flow chart of a method for detecting the surroundings of a motor vehicle.

FIG. 3 shows a flow chart of a method for processing a motor vehicle.

FIG. 4 shows a motor vehicle.

### DETAILED DESCRIPTION

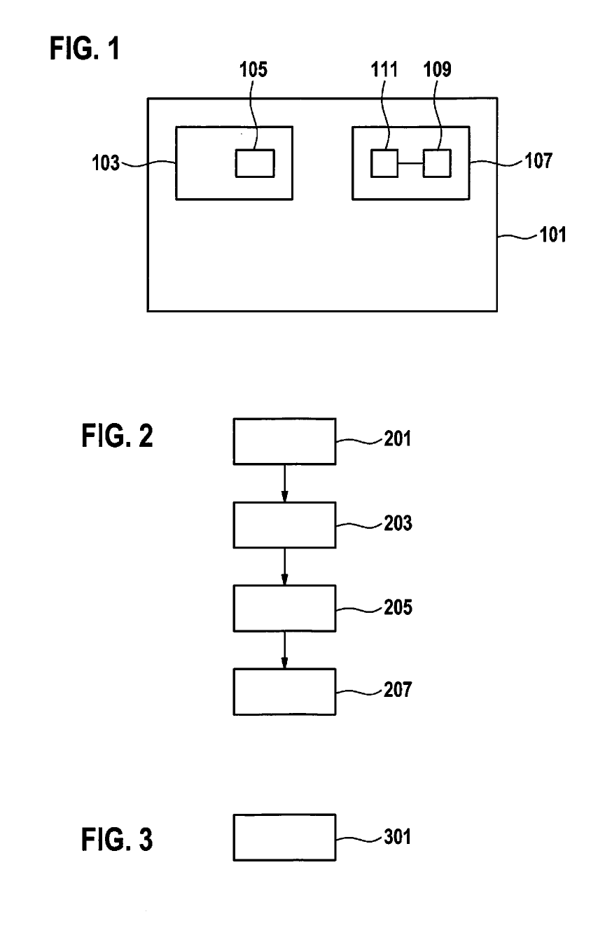

FIG. 1 shows a device 101 for detecting the surroundings of a motor vehicle.

Device 101 includes:
a data processing device 103 that includes a communication module 105 for wireless communication,
a sensor unit 107, in particular multiple sensor units, that include(s) a surroundings sensor 109, in particular multiple surroundings sensors, for detecting the surroundings of a motor vehicle, and a communication interface 111 for wirelessly transmitting surroundings sensor data corresponding to the detection to data processing device 103 via a wireless communications network,
communication module 105 being designed for wirelessly receiving the surroundings sensor data via the wireless communications network,
communication module 105 being designed for transmitting the surroundings sensor data and/or surroundings data based on the surroundings sensor data to a cloud server via a further wireless communications network.

According to one specific embodiment, it is provided that data processing device 103 is a mobile terminal, in particular a mobile telephone. In another specific embodiment, it is provided that data processing device 103 is a main control unit for a motor vehicle.

According to one specific embodiment, a motor vehicle is provided that includes device 101.

In one specific embodiment, it is provided that device 101 does not include data processing device 103.

According to one specific embodiment, it is provided that the data processing device is a mobile terminal, in particular a mobile telephone, of a vehicle occupant, in particular a driver of the motor vehicle.

In one specific embodiment, it is provided that data processing device 103 includes a position sensor for detecting a position of the motor vehicle. The position sensor is a GPS sensor, for example.

FIG. 2 shows a flow chart of a method for detecting the surroundings of a motor vehicle, using a device for detecting the surroundings of a motor vehicle, for example device 101 in FIG. 1.

The method includes the following steps:
detecting 201 the surroundings of a motor vehicle with the aid of the surroundings sensor(s),
wirelessly transmitting 203 surroundings sensor data corresponding to the detection to a data processing device of the motor vehicle via a wireless communications network, with the aid of the particular communication interface,
wirelessly receiving 205 the surroundings sensor data via the wireless communications network with the aid of the data processing device,
transmitting 207 the surroundings sensor data and/or surroundings data based on the surroundings sensor data to a cloud server via a further wireless communications network, with the aid of the data processing device.

This means in particular that the surroundings of the motor vehicle are detected with the aid of the sensor unit(s). This means in particular that the surroundings sensor data are transmitted to the data processing device with the aid of the particular communication interface of the sensor unit(s).

The data processing device includes in particular a communication module as described above.

For example, a wireless communications network such as a WLAN communications network or a Bluetooth communications network is installed within the motor vehicle, via which the surroundings sensor data are transmitted from the sensor unit(s) to the data processing device.

According to one specific embodiment, it is provided that the surroundings sensor data are transmitted in encrypted form.

According to one specific embodiment, it is provided that the surroundings sensor data are transmitted from the sensor unit(s) to the data processing device according to a WLAN standard or according to a Bluetooth standard.

FIG. 3 shows a flow chart of a method for processing a motor vehicle, the motor vehicle including one or multiple sensor units, each of which includes one or multiple surroundings sensors for detecting the surroundings of a motor vehicle, and a communication interface for wired transmission of surroundings sensor data corresponding to the particular detection via a bus, in particular a CAN bus, of the motor vehicle, one or multiple or all of the sensor units in each case being exchanged 301 with another sensor unit that in each case includes one or multiple surroundings sensors for detecting the surroundings of a motor vehicle, and a communication interface for wirelessly transmitting surroundings sensor data corresponding to the particular detection to a data processing device.

According to one specific embodiment, it is provided that only the sensor units laterally situated on the motor vehicle are exchanged. This means in particular, that only the lateral sensor units are exchanged.

This means in particular, that sensor units situated in or on the front area and/or on or in the rear area of the motor vehicle are not exchanged.

According to one specific embodiment, only the sensor units laterally situated on the right side of the motor vehicle are exchanged.

According to one specific embodiment, it is provided that only the sensor units laterally situated on the left side of the motor vehicle are exchanged.

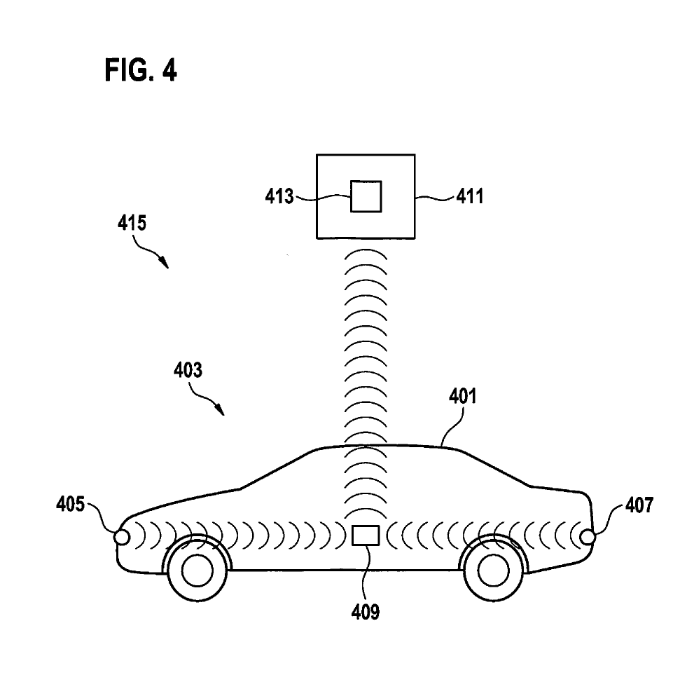

In the present context, “left” and “right” refer to a main travel direction of the motor vehicle. FIG. 4 shows a motor vehicle 401.

Motor vehicle 401 includes a device 403 for detecting the surroundings of a motor vehicle.

Device 403 includes two sensor units 405, 407, each of which includes one or multiple surroundings sensors for detecting the surroundings of motor vehicle 401, and a communication interface for wirelessly transmitting surroundings sensor data corresponding to the particular detection to a data processing device via a wireless communications network.

For the sake of clarity, the communication interface and the surroundings sensors of the two sensor units 405, 407 are not shown.

The two sensor units 405, 407 are, for example, laterally situated on motor vehicle 401, for example laterally on the right side of motor vehicle 401.

Device 403 includes a data processing device 409 that is designed, for example, as a mobile terminal, in particular as a mobile telephone.

Data processing device 409 includes a communication module as described above, the communication module not being shown in FIG. 4 for the sake of clarity.

The surroundings sensors of sensor units 405, 407 in each case detect the surroundings of motor vehicle 401, and transmit surroundings sensor data corresponding to this detection to data processing device 409 with the aid of the particular communication interface. This transmission is carried out via a wireless communications network, for example via a WLAN communications network or a Bluetooth communications network.

Data processing device 409 transmits, for example, these surroundings sensor data to a cloud server 411 via a further wireless communications network, for example a mobile radio communications network. This cloud server 411 is situated within a cloud infrastructure.

Cloud server 411 includes a communication interface 413 that is designed for receiving the surroundings sensor data from data processing device 409 via the further wireless communications network.

Cloud server 411 is designed, for example, to ascertain, based on the surroundings sensor data, vacant and/or occupied parking spaces in the surroundings of the motor vehicle as well as their positions, for example their GPS positions.

These pieces of information, in particular the positions of the vacant or occupied parking areas or parking spaces, are transmitted, for example, to motor vehicle 401 via the further wireless communications network. These pieces of information are transmitted, for example, to other motor vehicles (not shown) via the further wireless communications network, so that they obtain information concerning where occupied and/or vacant, i.e., unoccupied, parking spaces or parking areas are situated.

Thus, FIG. 4 also shows a system 415 for detecting the surroundings of a motor vehicle.

System 415 includes device 403 and cloud server 411.

Providing a cloud server 411 has the technical advantage in particular that the cloud server may carry out efficient computations. In particular, the cloud server may efficiently receive a plurality of surroundings sensor data or surroundings data from a plurality of motor vehicles, and correspondingly efficiently process same and transmit corresponding results of this processing (positions of the vacant and/or occupied parking spaces) to the plurality of motor vehicles.

According to one specific embodiment, it is provided that data processing device 409 is designed for displaying the information of cloud server 411 that is transmitted via the further wireless communications network.

Data processing device 409 includes, for example, a screen for displaying this information.

The present invention thus encompasses in particular the concept of exchanging sensor units already present on the motor vehicle with other sensor units that allow wireless transmission of corresponding surroundings sensor data. This means that the surroundings sensor data are wirelessly transmitted to the data processing device. This yields, for example, the technical advantage that, for example, no changes or modifications have to be made to a bus of a motor vehicle.

This means that the sensor units that are now installed after the exchange in the motor vehicle have a new functionality: cable-free or wireless communication.

Within the meaning of the description, the terms “cable-free” and “wireless” may be used synonymously.

This means that the newly installed sensor units each include a communication interface that is designed for communicating wirelessly, in particular for wirelessly transmitting the surroundings sensor data to a data processing device.

Thus, the surroundings sensor data, which may include raw surroundings sensor data, for example, may be transmitted to the data processing device, which is a mobile terminal, for example.

For example, the surroundings sensor data are transmitted in encrypted form.

For example, a position sensor for detecting a position of the motor vehicle is provided, so that a position may be associated with the surroundings sensor data. This means that a position of the motor vehicle, i.e., appropriate position data, is/are linked to the surroundings sensor data and/or the surroundings data.

For example, the data processing device includes a position sensor, so that the data processing device may detect or determine a position of the motor vehicle at the point in time that the surroundings of the motor vehicle are detected.

According to one specific embodiment, the data processing device is designed to ascertain, based on the surroundings sensor data, dimensions of a vacant space in the surroundings and/or dimensions of a space in the surroundings that is occupied by a motor vehicle, and to ascertain surroundings data corresponding to the ascertainment of the particular dimensions. The dimensions together with the corresponding positions of the vacant spaces and/or the occupied spaces are then transmitted to the cloud server via the further wireless communications network, for example with the aid of the data processing device.

According to one specific embodiment, it is provided that in addition to or instead of the above-described ascertainment of the dimensions of the vacant spaces and/or the occupied spaces with the aid of the data processing device, the computations in question are carried out with the aid of the cloud server.

According to one specific embodiment, the cloud server is designed for computing further data, based on the received surroundings sensor data and/or the received surroundings data, for example whether a vacant space is an entry point. For example, the cloud server ascertains whether a parking facility is completely full or whether there are still vacant parking spaces within a parking facility.

The data ascertained or computed by the cloud server are preferably transmitted to the data processing device and/or to other motor vehicles via the further wireless communications network, so that the data processing device, and/or the data processing devices of the other motor vehicles, may display these pieces of information.

According to one specific embodiment, it is provided that the data processing device is a “head unit”, i.e., a main control unit. According to this specific embodiment, it is provided that the main control unit includes a cable-free communication module, i.e., that the wireless or cable-free communication module may communicate wirelessly.

For example, it is provided that the communication module of the main control unit may communicate wirelessly via Bluetooth and/or WLAN.

This means that according to this specific embodiment, the surroundings sensor data are transmitted from the sensor unit(s) to the main control unit, and from the main control unit are then transmitted wirelessly to the cloud server via the further wireless communications network.

It is usual for a motor vehicle to already have a main control unit that includes an infotainment system, for example. A main control unit that is already present in the motor vehicle generally already includes a communication module for wireless communication. In currently known motor vehicles, it is provided via such a communication module that the main control unit communicates with a mobile telephone of a vehicle occupant, for example to play music, stored on the mobile telephone, with the aid of the infotainment system.

Thus, it is no longer necessary to make modifications to the main control unit with regard to hardware. Rather, it is sufficient for such a main control unit to obtain a software update. This is generally done with little effort, and in addition there are no extra hardware costs.

The concept according to the present invention now has the advantage in particular that existing motor vehicles, i.e., motor vehicles that are already manufactured, may become part of a system for also subsequently ascertaining vacant or occupied parking spaces, in particular vacant or occupiable parking spaces on a roadside. This is achieved according to the present invention with the aid of the device or by exchanging sensor units.

In particular, it is not necessary to make changes in a parking control unit of the motor vehicle. In particular, it is not necessary to make changes to or in the bus of the motor vehicle.

In particular, it is not necessary to install additional position detection components in the motor vehicle, provided that the data processing device already includes a position sensor.

In particular, it is not necessary to make changes to the main control unit except for the software update, provided that the communication is not to be carried out, for example, via the mobile telephone, but instead via the main control unit.

1.-16. (canceled)

17. A device for detecting surroundings of a motor vehicle, comprising:
at least one sensor unit that includes:
at least one surroundings sensor for detecting the surroundings of the motor vehicle, and
a communication interface for wirelessly transmitting surroundings sensor data, corresponding to a particular detection, to a data processing device via a wireless communications network, so that the data processing device transmits at least one of the surroundings sensor data and surroundings data based on the surroundings sensor data to a cloud server via a further wireless communications network.

18. The device as recited in claim 17, wherein:
the device includes the data processing device, and
the data processing device includes a communication module for wirelessly receiving the surroundings sensor data, and for transmitting the at least one of the surroundings sensor data and the surroundings data based on the surroundings sensor data to the cloud server via the further wireless communications network.

19. The device as recited in claim 17, wherein the data processing device is a mobile terminal.

20. The device as recited in claim 17, wherein the data processing device is a mobile telephone.

21. The device as recited in claim 17, wherein the data processing device is a main control unit for a motor vehicle.

22. The device as recited in claim 18, wherein:
the communication module includes:
a first communication interface for receiving the surroundings sensor data, and
a second communication interface, for transmitting the at least one of the surroundings sensor data and the surroundings data based on the surroundings sensor data to the cloud server.

23. The device as recited in claim 22, wherein:
the first communication interface includes one of a WLAN communication interface and a Bluetooth communication interface, and
the second communication interface includes a mobile radio communication interface.

24. The device as recited in claim 17:
the data processing device ascertains, based on the surroundings sensor data, at least one of dimensions of a vacant space in the surroundings and dimensions of a space in the surroundings that is occupied by the motor vehicle, and
the data processing device ascertains surroundings data corresponding to the ascertainment of the dimensions of the vacant space and the dimensions of the space occupied by the motor vehicle.

25. The device as recited in claim 17, further comprising:
a position sensor for detecting a position of the motor vehicle, wherein the data processing device transmits position data corresponding to a detection of the position to the cloud server via the further wireless communications network.

26. The device as recited in claim 25, wherein the position sensor is integrated into the data processing device.

27. The device as recited in claim 17, wherein:
the sensor unit encrypts the surroundings sensor data, and the communication interface of the sensor unit wirelessly transmits the encrypted surroundings sensor data to the data processing device.

28. A motor vehicle, comprising:
a device for detecting surroundings of a motor vehicle, the device including:
at least one sensor unit that includes:
at least one surroundings sensor for detecting the surroundings of the motor vehicle, and
a communication interface for wirelessly transmitting surroundings
sensor data, corresponding to a particular detection, to a data processing device via a wireless communications network, so that the data processing device transmits at least one of the surroundings sensor data and surroundings data based on the surroundings sensor data to a cloud server via a further wireless communications network.

29. A method for detecting surroundings of a motor vehicle using a device for detecting surroundings of a motor vehicle, the device including at least one sensor unit that includes at least one surroundings sensor for detecting the surroundings of the motor vehicle, and a communication interface for wirelessly transmitting surroundings sensor data, corresponding to a particular detection, to a data processing device via a wireless communications network, so that the data processing device transmits at least one of the surroundings sensor data and surroundings data based on the surroundings sensor data to a cloud server via a further wireless communications network, the method comprising:
detecting the surroundings of the motor vehicle with the aid of the surroundings sensor; and
wirelessly transmitting the surroundings sensor data, corresponding to the detection, with the aid of the communication interface to the data processing device of the motor vehicle via the wireless communications network, so that the surroundings sensor data may be received with the aid of the data processing device, so that the at least one of the surroundings sensor data and the surroundings data based on the surroundings sensor data is transmitted to the cloud server via the further wireless communications network with the aid of the data processing device.

30. The method as recited in claim 11, further comprising:
wirelessly receiving the surroundings sensor data via the wireless communications network with the aid of the data processing device; and
transmitting the at least one of the surroundings sensor data and the surroundings data based on the surroundings sensor data to the cloud server via the further wireless communications network, with the aid of the data processing device.

31. A method for processing a motor vehicle that includes a plurality of sensor units, each sensor unit including at least one surroundings sensor for detecting the surroundings of the motor vehicle, and a communication interface for a wired transmission of surroundings sensor data corresponding to a particular detection via a bus of the motor vehicle, the method comprising:
exchanging at least one of the sensor units with another one of the sensor units, each of the exchanged sensor units including a respective sensor unit and a respective communication interface for wirelessly transmitting the surroundings sensor data corresponding to the particular detection to a data processing device.

32. The method as recited in claim 31, wherein the bus is a CAN bus.

33. A system for detecting surroundings of a motor vehicle, comprising:
a device; and
a cloud server that includes a communication interface, wherein the device is for detecting surroundings of a motor vehicle and includes:
at least one sensor unit that includes:
at least one surroundings sensor for detecting the surroundings of the motor vehicle, and
a communication interface for wirelessly transmitting surroundings
sensor data, corresponding to a particular detection, to a data processing device via a wireless communications network, so that the data processing device transmits at least one of the surroundings sensor data and surroundings data based on the surroundings sensor data to the cloud server via a further wireless communications network, wherein the communication interface of the cloud server receives the at least one of the surroundings sensor data and the surroundings data based on the surroundings sensor data via the wireless communications network.

34. The system as recited in claim 33, wherein:
the cloud server ascertains, based on the at least one of the surroundings sensor data and the surroundings data based on the surroundings sensor data, at least one of dimensions of a vacant space in the surroundings and dimensions of a space in the surroundings that is occupied by the motor vehicle, and
the cloud server ascertains surroundings data corresponding to the ascertainment of the dimensions of the vacant space and the dimensions of the space occupied by the motor vehicle.

35. A computer program that includes program code for carrying out, when the computer program is executed on a computer, a method for detecting surroundings of a motor vehicle using a device for detecting surroundings of a motor vehicle, the device including at least one sensor unit that includes at least one surroundings sensor for detecting the surroundings of the motor vehicle, and a communication interface for wirelessly transmitting surroundings sensor data, corresponding to a particular detection, to a data processing device via a wireless communications network, so that the data processing device transmits at least one of the surroundings sensor data and surroundings data based on the surroundings sensor data to a cloud server via a further wireless communications network, the method comprising:
detecting the surroundings of the motor vehicle with the aid of the surroundings sensor; and
wirelessly transmitting the surroundings sensor data, corresponding to the detection, with the aid of the communication interface to the data processing device of the motor vehicle via the wireless communications network, so that the surroundings sensor data may be received with the aid of the data processing device, so that the at least one of the surroundings sensor data and the surroundings data based on the surroundings sensor data is transmitted to the cloud server via the further wireless communications network with the aid of the data processing device.
